(19) United States
(12) Patent Application Publication
(10) Pub. No.: US 2026/0272769 A1
(43) Pub. Date: Sep. 17, 2026

(54) MODULAR SKIN DISPLACEMENT DEVICE AND SYSTEM

(71) Applicant: Regents of the University of Minnesota, Minneapolis, MN (US)

(72) Inventors: Robert Michael Theodore Pettys-Baker, Minneapolis, MN (US); Bradley Holschuh, North Oaks, MN (US)

(21) Appl. No.: 19/470,173

(22) PCT Filed: Apr. 1, 2024
(86) PCT No.: PCT/US2024/022489

§ 371 Date: Sep. 29, 2025

Related U.S. Application Data
(60) Provisional application No. 63/493,555, filed on Mar. 31, 2023.
(60) Provisional application No. 63/507,163, filed on Jun. 9, 2023.

(51) Int. Cl. A61H 23/00; A61H 1/02

(52) U.S. Cl. CPC A61H 23/004; A61H 1/0285; A61H 2201/1638

(57) ABSTRACT

A device and system for producing a skin displacement experience for a user. The device includes a base, one or more actuators, each actuator including a shape memory alloy (SMA) coil and at least one eye, at least one attachment point mounted on the base and engaging with the at least one eye, and a skin interface mounted on the base and responsive to the one or more actuators at the at least one attachment point.

### CROSS REFERENCE TO RELATED APPLICATIONS

This application is being filed on 1 Apr. 2024, as a PCT international application and claims the benefit of and priority to U.S. Provisional Patent Application No. 63/493,555, filed on 31 Mar. 2023, titled “HOOK AND EYE ACTUATION SYSTEM FOR HAPTIC SKIN STRAIN”, and U.S. Provisional Patent Application No. 63/507,163, filed 9 Jun. 2023, titled “MODULAR SKIN DISPLACEMENT DEVICE AND SYSTEM”, the disclosures of which are hereby incorporated by reference in their entireties.

### BACKGROUND

The displacement of our skin is an innocuous part of daily life. The skin can passively strain to accommodate body movements and can actively encode the caring massage of a loved one. Skin strain is therefore a primary component in a person's engagement with the world around them.

Work in the area of producing or simulating skin strain has demonstrated that artificially produced skin strain can be used to accurately produce various touch sensations on the arm, which is desirable due to the touch sensitivity of the arms relative to other body areas. Beyond mere touch replication, skin strain can be used to provide context to actions including virtual and/or augmented reality. It has also been found that skin strain is experienced differently based on the stimulus orientation, and further that strain applied along the length of the arm is more perceivable than a strain applied around the circumference of the arm.

### SUMMARY

Aspects of the present disclosure relate to a device for producing a skin displacement experience for a user. The device may include a base; one or more actuators, each actuator of the one or more actuators including a shape memory alloy (SMA) coil and at least one eye; at least one attachment point mounted on the base and engaging with the at least one eye; and a skin interface mounted on the base and responsive to the one or more actuators at the at least one attachment point.

Other aspects of the present disclosure relate to a device for producing a skin displacement experience for a user. The device includes a base; one or more actuators, each actuator of the one or more actuators including a shape memory alloy (SMA) coil with a first eye on a first end and a second eye on a second, opposite, end; the first eye engaging with a first attachment point mounted on the base and the second eye engaging with a second attachment point mounted on the base; and a skin interface mounted on the base and responsive to the one or more actuators at the at least one attachment point.

Aspects of the present disclosure may as be implemented as a system incorporating the device or a method associated with the device.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates examples of skin strain, including an example of artificial skin strain, according to embodiments of the present disclosure.

FIG. 2 illustrated example skin displacement actuators 200, accordingly to embodiments of the present disclosure.

FIG. 3A illustrates the example actuators of FIG. 2 mounted on an example garment, according to embodiments of the present disclosure.

FIG. 3B shows an example of reconfiguring an embodiment of the present disclosure to provided skin strain experiences.

FIG. 4 illustrates an example interface of the garment of FIG. 3A, according to embodiments of the present disclosure.

FIG. 5 is another example of an embodiment of a skin displacement device, according to embodiments of the present disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts. Disclosed herein is a novel, wearable modular artificial skin displacement system that improves upon existing devices while also introducing new methods for integrating the actuation element.

Skin displacement, which includes skin strain, is a haptic stimuli that mimics common touch sensations like poking, pinching and massaging by using an actuator to move the skin. As used herein, skin displacement encompasses numerous possible skin movement sensations, including but not limited to straining, tugging, pinching, pressing, etc.

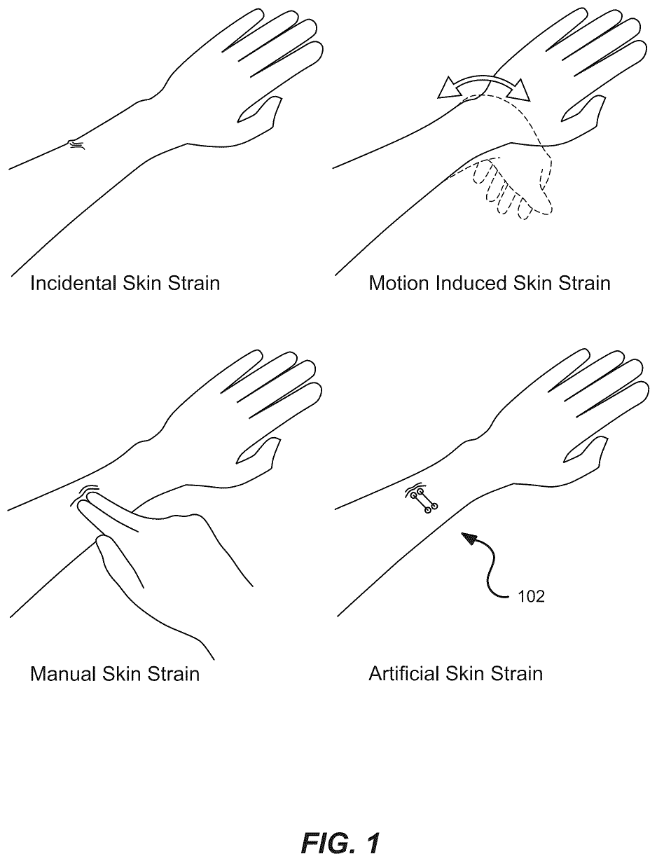

Skin strain is among the most common form of touch sensation people experience in their everyday lives. Despite this ubiquity, there has been limited success in creating skin displacement artificially through the use of wearable technology, making skin displacement an understudied mode of haptic interaction relative to other haptic modalities, e.g., vibration or compression. Skin strain is difficult to reproduce artificially on the body in ways that are effective functionally without sacrificing user experience. This is because skin strain requires a closer relationship with the skin than other haptic forms like vibration or compression. FIG. 1 illustrates examples of skin strain, including example artificial skin strain 102, according to embodiments of the present disclosure.

As discussed herein, incidental skin strain refers to when the skin is strained without direct intent to do so, such as bumping against an object that then pulls the skin. In this case skin strain isn't a desired or intentional sensation, and may impact the perception of other sensory cues in the environment. Motion induced skin strain refers to skin strain experienced as the body moves, how skin stretches and compresses in order to accommodate these motions. This form of skin strain is focused on internal forces displacing the skin compared to the other categories which are more (although not entirely) related to external stimuli. Manual skin strain refers to when the skin is strained directly by a hand, such as when massaging one's arm. This skin strain can be produced by an individual on themself, or a second party, and is generally intentional when it occurs. Artificial skin strain refers to when the skin is strained directly by an outside force that is mechanical or otherwise artificial, such as a mechanical actuator compressing while attached to the skin. It separates itself from incidental skin strain because it is an intentional stimulus that is meant to have some purpose or meaning.

Haptic devices in and of themselves fall into artificial skin strain. Yet, in creating these devices, those of skill in the art will recognize the importance of understanding that these other forms of strain are present and can work with or against one another. For example, even if trying to stay still, people will naturally move a little while wearing a skin strain device, meaning that both motion induced and artificial skin strain may occur simultaneously. Similarly, an individual may adjust a device on their arm while wearing it leading to both manual and artificial strain. An artificial skin strain system must therefore be developed around this understanding, adapting to the body and standing out as a stimulus.

The production of artificial skin strain feedback can be quite difficult because of the need to actively displace the skin, while also standing out from natural skin strain stimuli that can be produced unintentionally (e.g., a garment shifts the skin unintentionally during movement). A haptic skin strain device would desirably be held close enough to the skin to make contact, and have enough anchoring/attachment to the arm to allow for skin deformation. In addition, the actuation system would preferably be malleable enough to produce the dynamic range of feedback needed to create useful haptic experiences; for example, building in modularity in the system that can see skin strain deployed selectively or in a pattern. On top of these functional concerns, accounting for the manufacturability of the device and the general user experience raises further challenges. Further, full garments and/or other devices intended to provided a larger-scale experience present unique challenges to the perception of haptics that aren't seen in smaller single actuator devices. In particular, wearability and comfort concerns have the potential to be magnified as devices increase in size around the body.

It is notable that the what haptic strain is being produced by various experiences is diverse. Strains can be circumferentially produced around the body, circular around a central point, or linear to name a few examples. This diversity of touch display makes skin strain stand out from other haptic forms that are more limited in how they can be presented (e.g., compression and vibration). The direction movement of small single point skin strain movement have been detectable on the forearm in controlled studies, with movements as small as 0.13 mm. On both the dorsal and volar sides of the forearm, displacements of 2 mm may be detectable with great accuracy. Two-point threshold testing for skin strain has suggested that a distance of 3 cm is ideal for spacing skin strain stimuli. Skin strain is registered differently based on the stimulus orientation, with strain applied along the length of the arm being more perceivable than a strain applied around the circumference of the arm. Beyond mere touch replication, skin strain can be used to provide context to actions including virtual/augmented reality. With it even being able to be successfully registered as feedback for the fingers.

The present disclosure relates to a novel, wearable artificial skin displacement system. Advantages of the present disclosure includes, but are not limited to, improving means of producing artificial skin displacement on the body for ease of use and production, improving how the technical elements interface with the body, improving perception of skin displacement changes between body areas and orientations, providing modular actuator elements that enable simple and/or rapid reconfigurations of the actuators, and improving how artificial skin displacement interacts with unique features of the skin.

Many of the present devices in this area are focused on small scale formations, such as single actuator, which do not provide a significant or organic skin displacement experience. Larger areas of potential actuation allow for more dynamic applications of the stimulus, as well as improving understanding of the impact of skin displacement in a more realistic application. The actuation system disclosed herein allows for larger scale actuation and simplified production by applying traditional apparel manufacturing methods to assemble the device. This provided a skin displacement device that is more readily reproduced in conventional production facilities than present systems. The device and systems of the present disclosure also advantageously provide for effective anchoring with improved user comfort. Further advantages of the device of the present disclosure include size adjustability.

Skin strain devices according to the present disclosure have numerous applications for providing improved and novel experiences. For example, embodiments of the present disclosure provide replication of touch sensations of the body for augmented or virtual reality (AR/VR). Such touch sensations may include interpersonal touch replication, e.g., a user grabbing a VR character's arm or contacting their skin in some other way; indirect touch replication, e.g., bumping into objects or simulating the weight of virtual objects placed on the body; or ambient sensory stimulation, e.g., creating touch sensations on the body that don't relate to other specific stimuli, such as a physical interpretation of an emotional feeling a character has in a VR game. As another example, embodiments of the present disclosure may be used to provide caring touch replication for people who aren't physically near the other person, such as by rhythmic actuation or otherwise choreographed actuation to evoke a touch from a loved one in a natural way. Embodiments may provide non-invasive touch reminders. Skin strain need not be as forceful as, for example, conventional haptics, and so it can provide a more natural and less alarming touch reminder. Potential medical applications include skin sensitivity checking, e.g., producing touch stimuli around the arm/body to check user touch acuity; skin massage through rhythmic actuation or otherwise choreographed actuation; emotional regulation through touch sensation creating an active stimming sensation on the body; providing sensory information for body areas with low sensitivity, e.g., if a user's hand can't feel well providing touch sensations on the arm has been shown to replicate what should have been felt by the hand.

Aspects of the present disclosure provide a novel actuation system for implementation and simulating skin displacement. An advantageous actuator may include features such as being low-weight, comfortable on the body, cost-effective, and easy to integrate into garments and the manufacturing process. In addition, systems allowing for easy repair and replacement of actuators may minimize potential waste by providing a modular actuator and interface system. Skin displacement devices and systems of the present disclosure provide improvements in various applications and skin displacement experiences including, but not limited to, massage, skin sensitivity therapy, testing acuity based on a region of displacement, weight simulation, augmented reality, and touch therapy.

Shape Memory Alloy (SMA) actuators are one example of an effective actuator type for skin displacement. SMA springs in particular have the benefit of being small in size compared to other actuation methods, while still maintaining an acceptable level of actuation strength. This makes them easy to integrate into wearable forms. SMA are made from a blend of metals (typically nickel and titanium) that, when introduced to a heat/power source, will change shape as they transition between structural phases. This shape change can be manipulated based on how the material is structured, and can be trained to remember a specific shape. A common application is coiled (spring) actuators which can return their fully-contracted form after being stretched out.

Other modalities such as servo-motors and pneumatics may be implemented in a skin displacement context, but may add bulk and weight, making the wearing experience less pleasant. An advantage of using SMA are that they can be kept much closer to the body in comparison to other methods, such as servo motors and pneumatics, because of their small size. For example, small SMA springs lay very flat to the body but are able to present different forms of touch based on their configuration. By comparison, servo motor methods are limited to the direction of the motor and stand away from the body, which adds a lot of bulk and weight. Pneumatics can also lay flat to the body, but require a pump mechanism to properly actuate adding bulk and potentially limiting mobility.

Embodiment of the present disclosure include a soft robotic design that can adapt to different sizes. A soft robotic design can be achieved through traditional apparel manufacturing techniques, which is useful for improving repeatability and enabling production scaling. A soft robotic design can also better adapt to the body, enabling greater comfort for the user due to improved fit. Adjustability is also a key consideration, which can be enabled by using stretch materials for the base of the device, and selecting a closure method that allows for some sizing accommodation.

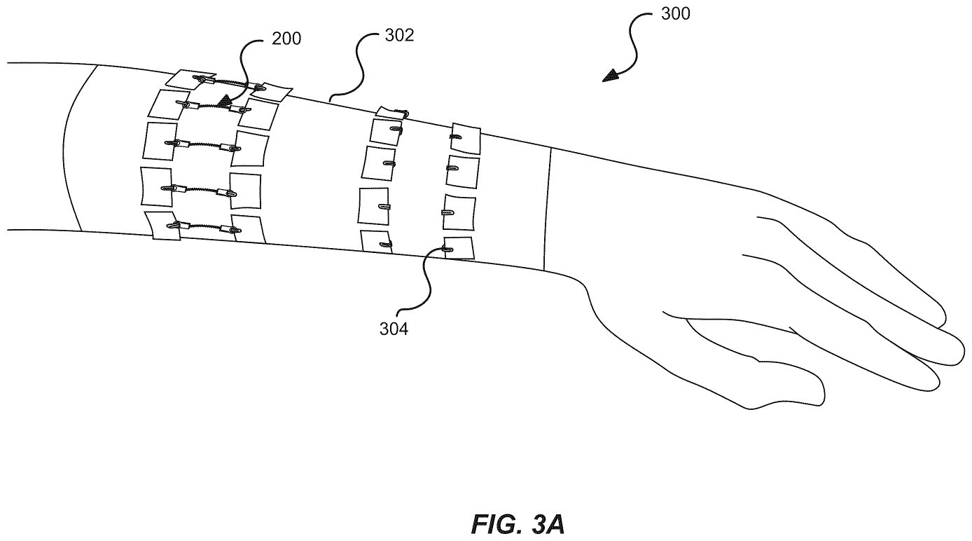

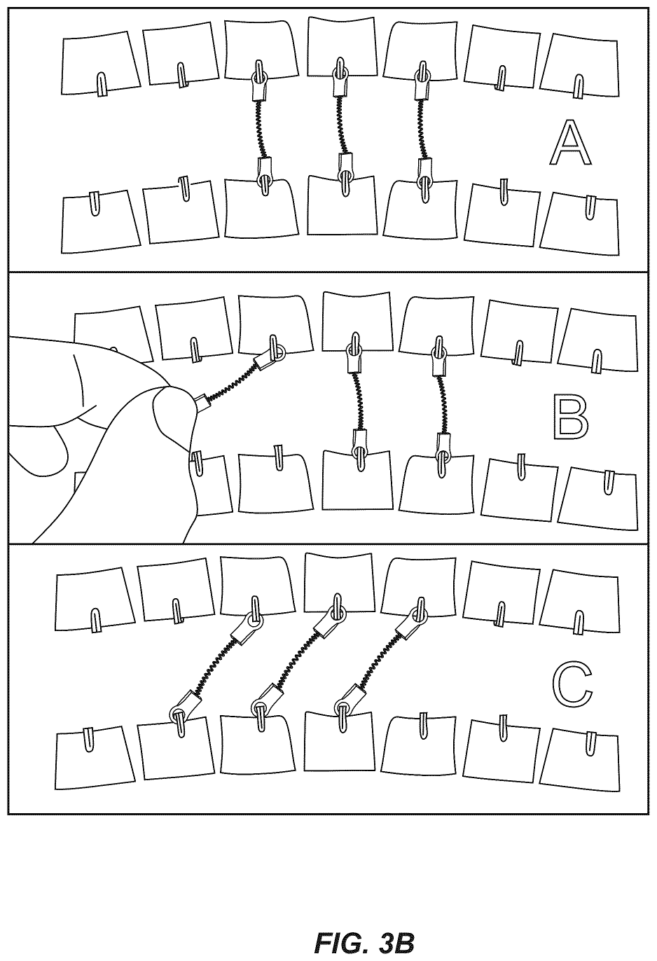

Disclosed herein is a novel hook-and-eye system which may be used, in some implementations to apply low-profile hooks to the surface of a garments. This system provides a reconfigurable actuator that is easy to manage and close to the surface of the garment. In embodiments, the core actuation component is a coiled SMA wire. In embodiments, the SMA coil is attached conductive metal snaps at each end. However, the use of snaps may be undesirable for use in a haptic skin strain device because the snap height lifts the actuators too high above the surface of the device. In embodiments, the SMA coils can be attached to conductive metal hooks sewn close to the surface of the garment. For example, by using the hook side of hook and eye tape one can attach SMA coils that have eye crimps on each end as shown in the example of FIG. 3A.

Hook and eye tape may be preferred in some embodiments to provide regular spacing of the hooks. In some examples presented herein, the spacing of the hooks is ¾″ apart from one another. In embodiments using hook and eye tape that does not stretch, the hook and eye tape may be initially sewn to a piece of elastic and then cut apart. The non-hook edge of the elastic may then be sewn onto a base fabric, and further glued to the silicone. This example method of attachment essentially creates a flap of elastic that makes it easier to remove the actuators as needed while also providing enough stretch to work with the base layer. Embodiments encompassing this design provide a standardized, repeatable manner for attaching the hooks to the garment. However, in some embodiments, the added elastic was found to add undesirable bulk and interfere with the presentation of the skin strain stimuli, as well as adding an extra step to the manufacturing process. Accordingly, in some embodiments, the elastic is removed to improve the speed of constructing new devices.

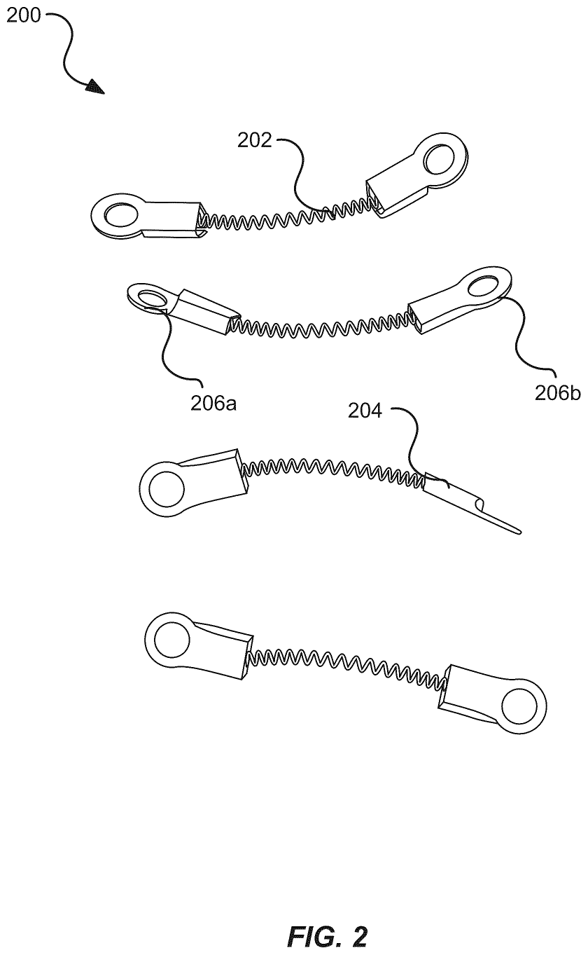

FIG. 2 illustrated example skin displacement actuators 200, accordingly to embodiments of the present disclosure. SMA coils 202 that have crimps 204 with holes 206a, 206b on each side of coil 202 to allow for actuators to be added or removed to hooks on a garment as desired. Holes 206 may also be characterized as “eyes” in the sense of being a receptacle for a thread or other fastening means. While crimps 204 are presented as one example for securing coils 202 to holes 206, it will be understood by those of skill in the art that alternative maybe used for providing engagement between the coils, springs, or other actuators and fixations points on the garment.

To make the eye crimps, the SMA coil is cut to the desired length with some additional length, e.g., plus about 2.5 mm, to allow extra room for crimping the coils. The coils may then manually or mechanically crimped, e.g., using a pair of pliers.

FIG. 3A illustrates example actuators 200 mounted on an example garment 300, according to embodiments of the present disclosure. Garment 300 may include a wearable base 302 and a plurality of actuator attachment points 304. In the present example, actuator attachment points 304 are configured as hooks, but other configurations are possible and contemplated. The present example is shown on a user's forearm, but the principals of the present disclosure are readily applicable to create a system that can be comfortably deployed around the body to present dynamic skin strain feedback.

In this example, a scuba knit base layer is used and the hook and eye actuation system is arranged at two locations on the base layer. In embodiments configured to be worn on a user's forearm, the two locations may correspond to the upper forearm and the wrist. In other examples, the actuation system may be arranged on more or fewer locations of a base layer, or may correspond to different regions of user's body. In embodiments, for each location two hook tapes are sewn facing one another spaced apart from one another. For example, tapes may be spaced ¼″, ½″, 1″, 2″, etc. apart. The hook and eye tape may sewn directly to the garment before being cut apart into individual hooks. This enables better SMA contact with the base layer, and allows for enhanced strain sensation compared with other designs.

As seen on example garment 300, the hooks may be placed across from each other to allow for the actuator to hook onto both sides. Multiple hooks can be placed next to one another to allow the user to switch the placement of the actuators. FIG. 3B shows an example of reconfiguring an embodiment of the present disclosure to provided skin strain experiences.

In embodiments, the actuators are electrically controlled through Joule heating by attaching wires to the metal hooks. This means that the hook-eye interface provides both mechanical and electrical engagement with each actuator, and offers extraordinary reconfigurability (as any number of actuators can be attached in any configuration across the available hooks). When in use, the actuators may powered individually to 0.75 A for 10 seconds.

This arrangement results in actuators that can be quickly repaired or replaced if broken. The actuators are readily moved into different formations to produce different touch sensations or changed to different lengths to alter the force properties of the touch sensations.

In embodiments, the number, placement, and orientation of the actuators arranged on the garment are also fully customizable, providing a high versatile skin displacement experience platform. Use of the hook-and-eye system to secure and arrange the actuators allows the actuators to be dynamically arranged and rearranged to supply varying skin displacement experiences. In some implementations, the hooks, eyes, or other fasteners may be arranged on the garment as a matrix. Any number of springs or other actuators may then be arranged on the matrix, with the number or the arrangement of the actuators readily adjusted from use-to-use or during use to alter or adjust the skin displacement experience.

While examples presented herein focus on skin displacement in the form of skin strain, those of skill in the art will recognize the disclosed actuation system is readily applicable in a variety of other haptic and skin displacement contexts, such as compression or assistive movement, based on how the actuator is formed on a garment or other implementation. Alternative formations of the SMA actuator, besides the coiled formation seen in example actuators 200, could also be used. For example, the SMA may be knitted, a plain wire, or sewn.

Aspects of the present disclosure also relate to how the device may be anchored or attached to the body to produce skin displacement sensation. Because skin displacement generally requires that the skin be actively moved, the actuation element may preferable conform to a user's body contours and be able to produce the needed forces. In some embodiments, actuators may be arranged over or along lines of non-extension on the skin to produce specific sensations or therapeutic touch or movement. Because the present disclosure provided for module and reconfigurable arrangement of the actuators, actuators can be periodically or continually rearranged or repositioned to alter the skin displacement produced.

Garment anchoring and comfort are key areas of consideration for any wearable device. Anchoring refers to how a device is held on the body, with the general goal of keeping components in a specific place. Anchoring is important for skin strain because the act of stretching the skin requires one or more points of contact with the skin (along with a controllable actuation/displacement) to achieve the stretching effect. In order to provide the desired perceptive effect, skin strain devices require strong contact with the skin. If a garment is too tight, the stimuli may be perceived as pressure and/or be uncomfortable to wear. On the opposite side, a loose device may produce sensations more akin to brushing or other light touches.

Adhesive, such as glue, has traditionally be used to anchor devices to the body. However, adhesive may be disadvantageous in some contexts because it limits skin displacement to relatively small applications, can cause discomfort during removal, and requires a lot of physical waste to replenish the adhesive properties.

Device shaping and patternmaking provides one example means of accounting for the shape of the body and providing a fit to achieve comfort and anchoring. As well, this offers pattern modification or size adjustment to adapt to the body and remain stable.

As disclosed herein, alternatives like silicone may be comparable in performance, while allowing repeated use and easy removal, and without requiring full adhesion to the body. Reducing or eliminating the use of adhesive also improves the reconfigurability of the device. A device may be reconfigured from use to use, or during use, such as to improve fit or produce an alternate sensation or experience. Proper fit is important to providing the desired skin strain experience. For example, if the device is too loose a strain stimulus may be confused with a brushing stimulus. If it is too tight the added compression may interfere with the perception of the strain stimuli. Silicone offers grip to the skin, without sacrificing performance. Anchoring can also be used in manipulating the device pattern to form to the body. This anchoring is especially important for creating a device that spans a larger area of the body. Traditional apparel patternmaking techniques can easily sculpt a device into desired shapes and use body landmarks as anchoring points as needed.

By combining the use of a silicone base layer with design fitting makes for the most effective stand in for skin adhesion. With silicone acting as the main griping agent, and easy resizing to ensure consistent fit between individuals.

Silicone is also beneficial in that it can act as insulation from the heat produced by SMA when active, which is a known challenge regarding on-body use of SMA actuators. Heat management is desirable to protect the user and provide a comfortable wearing experience, for instance in devices that use SMA actuators because they heat up when activated. Ideal insulation strategies should minimize the amount of heat felt by users while still allowing the desired haptic sensation to be registered. Conventionally, heat resistant materials and fabrics can be used as insulating underlayers, but covering the SMA directly with an outer layer is also an option. As noted above, silicone sheeting can also provide the desired thermal insulation while also doubling as a replacement for adhesion.

When it comes to comfort in wearables, aspects like pressure/constriction, texture, thermal balance, moisture transport, and freedom of movement are important to consider. This can also be expanded to more general guidelines like how components are placed and attached, and the sizing of devices.

Comfort considerations help to ensure a positive user experience. A device can be highly functional and effective, but if users don't enjoy the experience of wearing and using the device it. Examples of comfort considerations include managing the amount of skin strain so as not to over-strain the skin, avoiding direct adhesion to reduce skin irritation, and creating a device that isn't bulky and heavy.

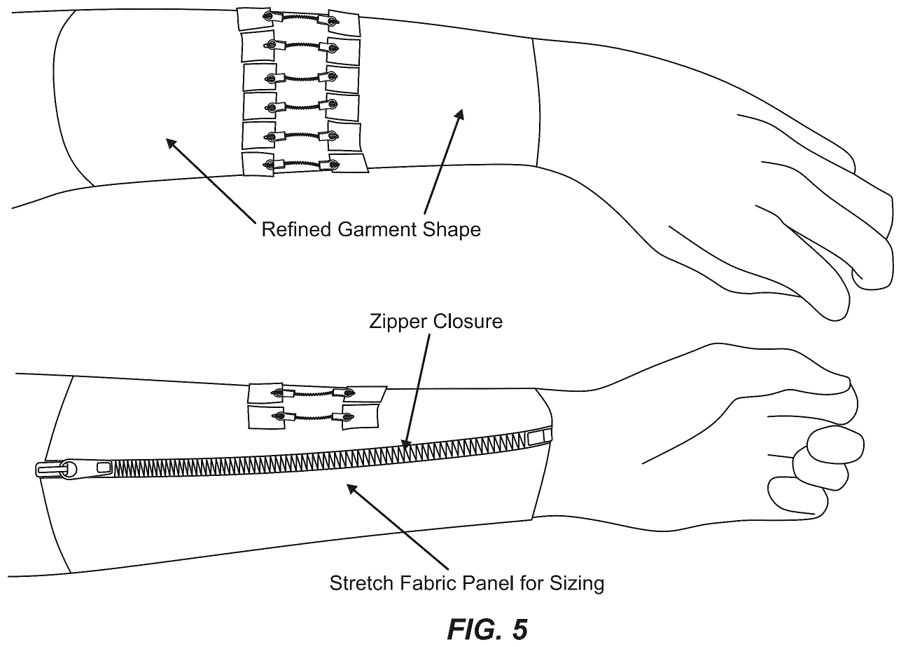

FIG. 5 is another example of an embodiment of a skin displacement device, according to embodiments of the present disclosure. Actuation in this embodiment is strengthened by adding a second SMA coil into the crimp, altering the pattern of the fabric base to add a stretch fabric panel to accommodate user variability, and changing the closure to a zipper for more consistent fastening and fit. The results of this embodiments may be more consistent and provide a more universal touch experience. Consistency may be a consideration of significant importance in some implementations, as a litany of subjective touch experiences can be felt with no major modifications to how a stimulus is delivered/presented to a user. This demonstrates how dynamic skin stretch can be as a touch sensation, but the value for controlling the variety of sensations presented, in some implementations, so that a consistent user experience can be provided. In embodiments, variability in skin stretch devices can be reduced through smart design choices focused on adaptability to work with the body. This in turn allows for a more precisely controlled experience to ensure all users receive comparable skin stretch stimuli despite natural body variability between users.

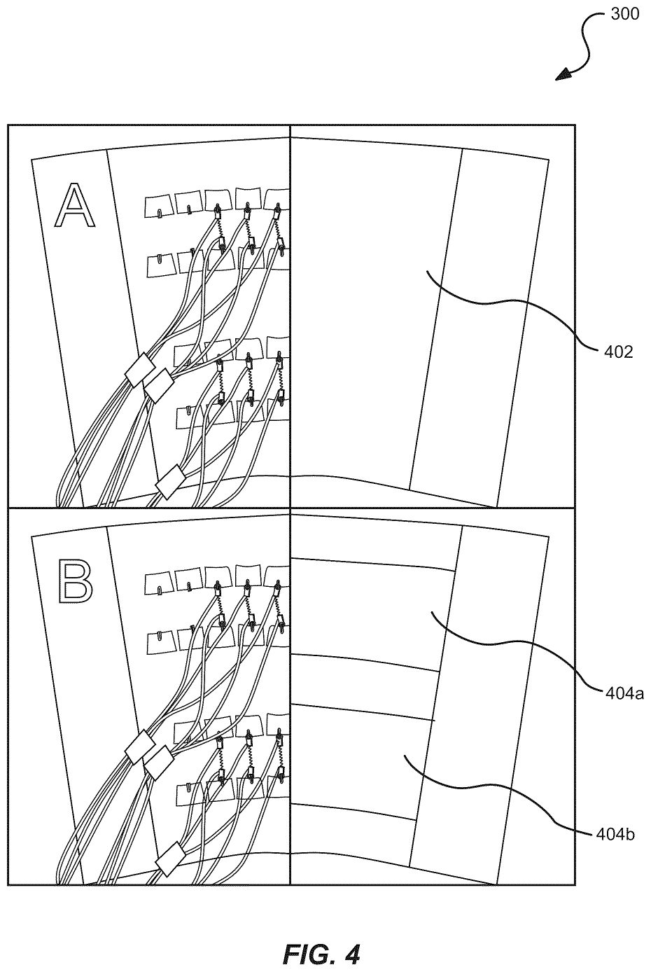

According to aspects of the present disclosure, silicone, or a comparable material or interface, may be used in tandem with manipulations to a garment's pattern to yield a skin displacement interface to better work with the body, adapt to body landmarks and physiology, and minimize or eliminate the needs for adhesion. In combination with the actuation system, this interface provides improved skin engagement and skin displacement experience by a user. FIG. 4 illustrates an example interface 402 of the garment 300 of FIG. 3, according to embodiments of the present disclosure.

In the example of FIG. 4, interface 402 is illustrated as continuous sheet covering much of the area of the garment 300, but other arrangements are envisioned. The interface 402 may be configured with any number of high-friction regions, arranged, for example, as rows or columns, as individual dots or squares, etc. Each friction region may be characterized as a “grip point” for the skin of a user, so that when the actuators contract, the grip points determine which skin regions get stretched, pinched, etc., such that the grip points, and the associated sensations experienced by the user, can be fully customized.

As noted above, the example interface 402 is presented as a continuous sheet of, for example, silicone. In embodiments, other configurations and arrangements of the interface are envisioned. For example, rather than a continuous sheet, the interface may be configured as an arrangement of a number of small portions 404a, 404b of interface materials. Each portion may be formed of a same material, e.g., silicone, or different portions may be formed of different interface materials. Interface portions of differing size and shape may be combined within a common garment to produce various effects and sensations for a wearer.

The arrangement of the silicone may be selected for a particular implementation based on how the silicone impacts the perception and enjoyment of the skin strain stimuli. A full sheet of silicone may better mimic natural skin movement, but limits breathability for the skin. The more localized silicone therefore gives more room for the skin to breath while limiting where the strain might be felt.

The garment anchoring to the body may be based on both the silicone and patterned anchoring. Many types of silicone are effective and appropriate for embodiment of the present disclosure, but in some cases silicone suitable for pouring into a thin sheet and/or with higher extensibility due to a low shore value may provide greater

The silicone may be attached to a fabric backing, such as by pouring onto fabric or by placing the fabric on top of the silicone during curing. However, these methods may be limiting by tending to oversaturate the fabric and/or produce an uneven texture. In embodiments, a glue, which may specifically be a silicone glue, may be used to attach the fabric to the silicone post-curing. This allows for enough fabric saturation to ensure a strong attachment, but not so much that it interferes with components or creates uneven texture.

In embodiments, the fabric backing is selected to have an adequate stretch to conform to the body and addresses some sizing variability.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A device for producing a skin displacement experience for a user, the device comprising:
a base;
one or more actuators, each actuator of the one or more actuators including a shape memory alloy (SMA) coil and at least one eye;
at least one attachment point mounted on the base and engaging with the at least one eye; and
a skin interface mounted on the base and responsive to the one or more actuators at the at least one attachment point.

2. The device of claim 1, wherein the skin interface comprises a silicone sheet.

3. The device of claim 2, wherein the silicone sheet is mounted on the base by a glue.

4. The device of claim 3, wherein the glue is a silicone glue.

5. The device of claim 1, wherein the skin interface comprises at least two portions.

6. The device of claim 5, wherein the at least two portions are spaced apart from one another.

7. The device of claim 6, further comprising a plurality of attachment points, wherein each of the at least two portions is arranged to locationally correspond to at least one of the plurality of attachment points.

8. The device of claim 1, wherein the base has a first side and a second opposite side and wherein the skin interface is mount on the first side and the at least one attachment point is mounted on the second side.

9. The device of claim 1, wherein each actuator of the one or more actuators further includes a second eye arranged on an opposite end of the SMA coil from the at least one eye and engaging with a second attachment point mounted on the base.

10. The device of claim 1, further comprising a power source applied to the at least one attachment point.

11. The device of claim 10, wherein the SMA coil contracts and generates the skin displacement experience in response to power being applied by the power source.

12. The device of claim 1, wherein the base comprises a stretch fabric.

13. A method of producing a skin displacement experience for a user, the method comprising:
providing a skin displacement device including:
a plurality of attachment points;
a plurality of actuators attached to a first portion of the plurality of attachment points;
generating a first skin displacement experience by activating a first configuration of the plurality of actuators; and
generating a second skin displacement experience by activating a second configuration of the plurality of actuators.

14. The method of claim 13, further comprising generating a third skin displacement experience by rearranging the plurality of actuators to attach to at least a second portion of the plurality of attachment points and generating the third skin displacement experience by a activating a third configuration of the plurality of actuators.

15. The method of claim 14, wherein the second portion is a unique combination of the plurality of attachment points in comparison with the first portion.

16. The method of claim 14, wherein the first portion and the second portion of the plurality of attachment points have at least one attachment point in common.

17. The method of claim 16, wherein the at least one attachment point in common is connected to a first attachment point in the first portion and a second different attachment point in the second portion.

18. A device for producing a skin displacement experience for a user, the device comprising:
a base;
one or more actuators, each actuator of the one or more actuators including a shape memory alloy (SMA) coil with a first eye on a first end and a second eye on a second, opposite, end;
the first eye engaging with a first attachment point mounted on the base and the second eye engaging with a second attachment point mounted on the base; and
a skin interface mounted on the base and responsive to the one or more actuators at the at least one attachment point.

19. The device of claim 18, further comprising a power source configured to activate the one or actuators to the draw the first and second attachment points together.

20. The device of claim 19, wherein the power source is arranged in communication with the at least one attachment point.
